(19) United States
(12) Patent Application Publication
(10) Pub. No.: US 2025/0175280 A1
(43) Pub. Date: May 29, 2025

(54) METHOD AND APPARATUS FOR DETERMINING TRANSMISSION PARAMETER, NETWORK SIDE DEVICE, AND MEDIUM

(71) Applicant: VIVO MOBILE COMMUNICATION CO., LTD., Dongguan (CN)

(72) Inventor: Jinhua LIU, Dongguan (CN)

(73) Assignee: VIVO MOBILE COMMUNICATION CO., LTD., Dongguan (CN)

(21) Appl. No.: 19/037,289

(22) Filed: Jan. 27, 2025

Related U.S. Application Data
(63) Continuation of application No. PCT/CN2023/110255, filed on Jul. 31, 2023.

(30) Foreign Application Priority Data
Aug. 5, 2022 (CN) 202210939931.2

(51) Int. Cl. H04L 1/00; H04W 72/20

(52) U.S. Cl. CPC H04L 1/0041; H04W 72/20

(57) ABSTRACT

This application provides a method and apparatus for determining a transmission parameter, a network side device, and a medium. The method for determining a transmission parameter of embodiments includes: receiving, by a forwarding node, auxiliary information from a first network side device; determining, by the forwarding node, a second transmission channel associated with the first transmission channel according to the auxiliary information; and determining, by the forwarding node, a transmission parameter of the first transmission channel according to a transmission parameter of the second transmission channel. The auxiliary information is configured to indicate information related to a first transmission channel. The first transmission channel is an uplink channel or a downlink channel whose radio signal is to be forwarded between the forwarding node and a terminal. A transmission direction of the second transmission channel is different from a transmission direction of the first transmission channel.

### CROSS-REFERENCE TO RELATED APPLICATIONS

The disclosure is a continuation of International Application No. PCT/CN 2023/110255, filed on Jul. 31, 2023, which claims the priority to Chinese Patent Application No. 202210939931.2, filed on Aug. 5, 2022. The entire contents of each of the above-referenced applications are expressly incorporated herein by reference.

### TECHNICAL FIELD

The disclosure pertains to the technical field of communication, and specifically, to a method and apparatus for determining a transmission parameter, a network side device, and a medium.

### BACKGROUND

At present, information between an access network device and a terminal can be forwarded by a forwarding node in a New Radio (NR) system. Accordingly, the access network device can be in communication with the terminal, and coverage of the access network device can be extended. In general cases, when the information between the access network device and the terminal is forwarded by the forwarding node, beam training needs to be conducted on a downlink beam and an uplink beam between the forwarding node and the terminal separately. In this way, transmission parameters of a downlink channel and an uplink channel between the forwarding node and the terminal are determined. Thus, the information between the access network device and the terminal can be forwarded by the forwarding node according to the transmission parameters of the downlink channel and the uplink channel.

However, because the forwarding node needs to conduct beam training on the downlink beam and the uplink beam between the forwarding node and the terminal separately, high resource and time consumption of the forwarding node will be caused probably. This results in a decrease in resources for information transmission and an increase in a transmission delay. Thus, forwarding performance of the forwarding node is deteriorated.

### SUMMARY

Embodiments of the disclosure provide a method and apparatus for determining a transmission parameter, a network side device, and a medium.

A first aspect provides a method for determining a transmission parameter. The method is applied to a forwarding node. The method includes: receiving, by a forwarding node, auxiliary information from a first network side device, where the auxiliary information is configured to indicate information related to a first transmission channel, and the first transmission channel is: an uplink channel or a downlink channel whose radio signal is to be forwarded between the forwarding node and a terminal; determining, by the forwarding node, a second transmission channel associated with the first transmission channel according to the auxiliary information; and determining, by the forwarding node, a transmission parameter of the first transmission channel according to a transmission parameter of the second transmission channel. A transmission direction of the second transmission channel is different from a transmission direction of the first transmission channel.

A second aspect provides an apparatus for determining a transmission parameter. The apparatus for determining a transmission parameter includes: a reception module and a determination module. The reception module is configured to receive auxiliary information from a first network side device. The auxiliary information is configured to indicate information related to a first transmission channel. The first transmission channel is: an uplink channel or a downlink channel whose radio signal is to be forwarded between the apparatus for determining a transmission parameter and a terminal. The determination module is configured to determine a second transmission channel associated with the first transmission channel according to the auxiliary information received by the reception module; and determine a transmission parameter of the first transmission channel according to a transmission parameter of the second transmission channel. A transmission direction of the second transmission channel is different from a transmission direction of the first transmission channel.

A third aspect provides a method for determining a transmission parameter. The method is applied to a first network side device. The method includes: transmitting, by a first network side device, auxiliary information to a forwarding node, where the auxiliary information is configured to indicate information related to a first transmission channel. The first transmission channel is: an uplink channel or a downlink channel whose radio signal is to be forwarded between the forwarding node and a terminal. The auxiliary information is configured to enable the forwarding node to determine a second transmission channel associated with the first transmission channel, such that a transmission parameter of the first transmission channel is determined according to a transmission parameter of the second transmission channel. A transmission direction of the second transmission channel is different from a transmission direction of the first transmission channel.

A fourth aspect provides an apparatus for determining a transmission parameter. The apparatus for determining a transmission parameter includes: a transmission module. The transmission module is configured to transmit auxiliary information to a forwarding node. The auxiliary information is configured to indicate information related to a first transmission channel. The first transmission channel is: an uplink channel or a downlink channel whose radio signal is to be forwarded between the forwarding node and a terminal. The auxiliary information is configured to enable the forwarding node to determine a second transmission channel associated with the first transmission channel, such that a transmission parameter of the first transmission channel is determined according to a transmission parameter of the second transmission channel. A transmission direction of the second transmission channel is different from a transmission direction of the first transmission channel.

A fifth aspect provides a network side device. The network side device includes a processor and a memory. The memory stores a program or an instruction runnable on the processor. When the program or the instruction is executed by a processor, steps of the method according to the first aspect are implemented, and in some embodiments, steps of the method according to the third aspect are implemented.

A sixth aspect provides a network side device. The network side device includes a processor and a communication interface. The communication interface is configured to receive auxiliary information from a first network side device. The auxiliary information is configured to indicate information related to a first transmission channel. The first transmission channel is: an uplink channel or a downlink channel whose radio signal is to be forwarded between a forwarding node and a terminal. The processor is configured to determine a second transmission channel associated with the first transmission channel according to the auxiliary information; and determine a transmission parameter of the first transmission channel according to a transmission parameter of the second transmission channel. A transmission direction of the second transmission channel is different from a transmission direction of the first transmission channel. For example, the communication interface is configured to transmit the auxiliary information to the forwarding node. The auxiliary information is configured to indicate information related to a first transmission channel. The first transmission channel is: an uplink channel or a downlink channel whose radio signal is to be forwarded between the forwarding node and a terminal. The auxiliary information is configured to enable the forwarding node to determine a second transmission channel associated with the first transmission channel, such that a transmission parameter of the first transmission channel is determined according to a transmission parameter of the second transmission channel. A transmission direction of the second transmission channel is different from a transmission direction of the first transmission channel.

A seventh aspect provides a system for determining a transmission parameter. The system includes: a forwarding node and a first network side device. The forwarding node is configured to execute steps of the method according to the first aspect. The first network side device is configured to execute steps of the method according to the third aspect.

An eighth aspect provides a readable storage medium. The readable storage medium stores a program or an instruction. When the program or the instruction is executed by a processor, steps of the method according to the first aspect are implemented, and in some embodiments, steps of the method according to the third aspect are implemented.

A ninth aspect provides a chip. The chip includes a processor and a communication interface. The communication interface is coupled to the processor. The processor is configured to run a program or an instruction, such that steps of the method according to the first aspect are implemented, and in some embodiments, steps of the method according to the third aspect are implemented.

A tenth aspect provides a computer program/program product. The computer program/program product is stored in a storage medium. The computer program/program product is executed by at least one processor, such that steps of the method according to the first aspect are implemented, and in some embodiments, steps of the method according to the third aspect are implemented.

In the embodiment of the disclosure, the forwarding node may first receive the auxiliary information configured to indicate the information related to the first transmission channel from the first network side device. Then, the second transmission channel associated with the first transmission channel is determined according to the auxiliary information. Thus, the forwarding node may determine the transmission parameter of the first transmission channel according to the transmission parameter of the second transmission channel. The first transmission channel is: the uplink channel or the downlink channel whose radio signal is to be forwarded between the forwarding node and the terminal. The transmission direction of the second transmission channel is different from the transmission direction of the first transmission channel. The forwarding node may determine the second transmission channel associated with the first transmission channel according to the auxiliary information transmitted by the first network side device. In this way, the forwarding node may directly determine the transmission parameter of the first transmission channel according to the transmission parameter of the second transmission channel, and beam training does not need to be conducted on the downlink beam and the uplink beam between the forwarding node and the terminal separately, such that the transmission parameter of the first transmission channel can be determined. Thus, resource and time consumption of the forwarding node can be reduced, and an increase in resources for information transmission and a decrease in a transmission delay can be achieved. In this way, forwarding performance of the forwarding node can be improved.

### BRIEF DESCRIPTION OF THE DRAWINGS

FIG. 1 is a schematic diagram of a logical structure of a reconfigurable intelligent surface (RIS) node in the related art;

FIG. 2 is a schematic diagram of a logical structure of a network controlled repeater (NCR) node in the related art;

FIG. 3 is a schematic diagram of reciprocity of an uplink channel and a downlink channel of an access link in the related art;

FIG. 4 is a block diagram of a radio communication system according to an embodiment of the disclosure;

FIG. 5 is a first schematic flow diagram of a method for determining a transmission parameter according to an embodiment of the disclosure;

FIG. 6 is a second schematic flow diagram of a method for determining a transmission parameter according to an embodiment of the disclosure;

FIG. 7 is a third schematic flow diagram of a method for determining a transmission parameter according to an embodiment of the disclosure;

FIG. 8 is a schematic diagram of a signaling flow between a forwarding node and a first network side device of a method for determining a transmission parameter according to an embodiment of the disclosure;

FIG. 9 is a first schematic structural diagram of an apparatus for determining a transmission parameter according to an embodiment of the disclosure;

FIG. 10 is a second schematic structural diagram of an apparatus for determining a transmission parameter according to an embodiment of the disclosure;

FIG. 11 is a schematic structural diagram of a communication device according to an embodiment of the disclosure; and

FIG. 12 is a schematic diagram of a hardware structure of a network side device according to an embodiment of the disclosure.

### DETAILED DESCRIPTION

Technical solutions in embodiments of the disclosure will be clearly described below with reference to accompanying drawings in the embodiments of the disclosure. Obviously, the embodiments described are some embodiments rather than all embodiments of the disclosure. Based on the embodiments of the disclosure, all other embodiments obtained by those of ordinary skill in the art should fall within the protection scope of the disclosure.

Terms involved in the embodiments of the disclosure will be illustrated below.

### 1, Layer (L) 1 Forwarding Node

Generally, the L1 forwarding node may include a Reconfigurable Intelligent Surface (RIS) node and a Network Controlled Repeater (NCR) node. The RIS node and the NCR node may extend coverage of a cell under control of an access network device.

### (1) RIS Node

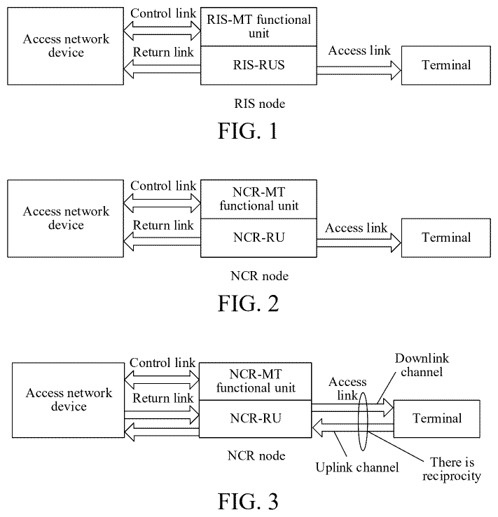

The RIS node may include an RIS-terminal (Mobile Termination (MT)) functional unit and an RIS-Reflection Surface Unit (RSU). As shown in FIG. 1, the RIS-MT functional unit is configured to establish a radio connection between the RIS node and an access network device, enable the RIS node to transmit a measurement report of the RIS node to the access network device, and enable the access network device to reflect control signaling for the RIS node. The RIS-RSU is configured to conduct reflection transmission of signals between the access network device and a terminal, and includes a Synchronization Signal Block (SSB), a system message, uplink and downlink specific signaling, an uplink and downlink control channel, an uplink and downlink data channel, etc.

The RIS-MT functional unit may use an independent antenna, or may share an antenna (or a radio signal reception medium) on the RIS-RSU.

An RIS-RSU control unit (for example, an antenna panel controller) is provided between the RIS-MT functional unit and the RIS-RSU, such that the RIS-MT functional unit may receive signaling configured to control the RIS-RSU control unit from the access network device, and transmit the signaling to the RIS-RSU control unit. Thus, the RIS-RSU control unit may adjust a phase amplitude matrix of a reflection array of an RIS-RSU unit, so as to adjust a transmission parameter (for example, a reflection beam parameter) of the RIS-RSU.

### (2) NCR Node

A Network Controlled Repeater (NCR) node, also referred to as a smart repeater, may receive and amplify a downlink signal from an access network device, such that strength of the downlink signal reaching a terminal is enhanced. For example, an uplink signal from the terminal may be amplified, such that strength of the uplink signal reaching an access network device is enhanced. As shown in FIG. 2, the NCR node may include an NCR-MT functional unit and an NCR-Radio Unit (RU). The NCR-MT may be connected to the access network device, such that the access network device may exchange control signaling with a signal amplifier of the NCR node through the NCR-MT. Thus, transmission or reception related parameters of the NCR-MT (or the NCR-RU) of the signal amplifier are indicated, such that operating efficiency of the NCR node is improved, and interference is reduced. The NCR-RU is configured to forward a radio signal between the access network device and the terminal, so as to increase strength of the radio signal.

### 2, Channel Correspondence (Reciprocity) of an Access Link of an L1 Forwarding Node

The channel correspondence of the access link may be referred to as reciprocity between uplink and downlink channels of the access Link, or correspondence between uplink and downlink channels of the access link. In essence, characteristics of uplink channels of a same access link are similar. That is, transceiving beam directions, transceiving beam widths, transceiving beam gains, channel orders, multipath characteristics, beamforming parameters, etc. of the uplink and downlink channels are similar. Thus, according to a transmission parameter of a channel in one transmission direction (for example, an uplink or downlink direction) of the same access link, a transmission parameter of a channel in another transmission direction (for example, a downlink or uplink direction) of the same access link may be determined.

As shown in FIG. 3, reciprocity exists between an uplink channel (uplink forwarding) Uplink and a downlink channel (downlink forwarding) Downlink of an access link between the NCR node and the terminal. Thus, a transmission parameter of the Downlink may be determined according to a transmission parameter of the Uplink, or a transmission parameter of the Uplink may be determined according to a transmission parameter of the Downlink.

### 3, Other Terms

In the description and claims of the disclosure, terms such as “first” and “second” are intended to distinguish between similar objects but are not used to indicate a specific order or sequence. It should be understood that terms used in this way can be interchanged under appropriate circumstances, such that the embodiment of the disclosure can be implemented in a sequence other than those illustrated or described herein. In addition, the objects distinguished by “first” or “second” are generally objects of a same type with a number of objects unlimited. For example, a first object can indicate one or more first objects. In addition, “and/or” in the description and the claims represents at least one of connected objects, and the character “/” generally represents an “or” relation between two associated context objects.

It is worth pointing out that the technology described in the embodiment of the disclosure is not limited to a Long Term Evolution (LTE)/LTE-Advanced (LTE-A) system, and can also be used in other radio communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of the disclosure are generally used interchangeably, and the described technology can be applied to the systems and radio technologies described above, or applied to other systems and radio technologies. The following description describes a New Radio (NR) system for illustration. NR terms are used in most of the following description, but the technologies can be applied to applications other than NR system applications, such as a 6^{th} Generation (6G) communication system.

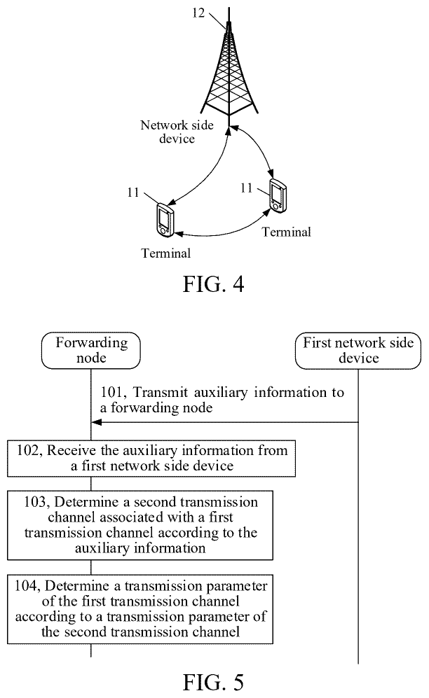

FIG. 4 shows a block diagram of a radio communication system applied to an embodiment of the disclosure. The radio communication system includes a terminal 11 and a network side device 12. The terminal 11 may be a mobile phone, a tablet personal computer, a laptop computer or a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a wearable device, vehicle user equipment (VUE), pedestrian user equipment (PUE), a smart home appliance (home equipment having a radio communication function, such as a refrigerator, a television, a washing machine or furniture), and terminal side devices such as a game machine, a personal computer (PC), a teller machine or a self-service machine. The wearable device includes: a smart watch, a smart band, a smart headset, smart glasses, smart jewelry (a smart bracelet, a smart chain bracelet, a smart ring, a smart necklace, a smart anklet, a smart ankle chain, etc.), a smart wrist strap, a smart garment, etc. It should be noted that a specific type of the terminal 11 is not limited by the embodiment of the disclosure. The network side device 12 may include an access network device or a core network device. In some embodiments, the access network device 12 may be referred to as a radio access network device, a Radio Access Network (RAN), a radio access network function, or a radio access network unit. The access network device 12 may include a base station, a wireless local area network (WLAN) access point, a wireless fidelity (WiFi) node, etc. The base station may be referred to as a node B, an evolution node B (eNB), an access point, a Base Transceiver Station (BTS), a radio base station, a radio transceiver, a Basic Service Set (BSS), an Extended Service Set (ESS), a home B node, a home evolution type B node, a Transmitting Receiving Point (TRP), or any other suitable term in the art, as long as same technical effects are achieved. The base station is not limited to a particular technical vocabulary. It should be noted that in the embodiment of the disclosure, only a base station in an NR system is described as an example, and a specific type of the base station is not limited.

The method and apparatus for determining a transmission parameter, the network side device and the medium according to the embodiment of the disclosure will be described in detail below through some embodiments and their application scenes with reference to the accompanying drawings.

In the related art, when a forwarding node forwards information between an access network device and a terminal, beam training needs to be first conducted on a beam between the forwarding node and the terminal.

In one scene, the forwarding node needs to conduct beam training on a downlink beam and an uplink beam between the forwarding node and the terminal separately. In this way, transmission parameters of a downlink channel and an uplink channel between the forwarding node and the terminal are determined. Thus, the information between the access network device and the terminal can be forwarded by the forwarding node according to the transmission parameters of the downlink channel and the uplink channel. However, because the forwarding node needs to conduct beam training on the downlink beam and the uplink beam between the forwarding node and the terminal separately, high resource and time consumption of the forwarding node will be caused probably. This results in a decrease in resources for information transmission and an increase in a transmission delay.

In another scene, the forwarding node may conduct beam training on only one uplink beam (or one downlink beam) between the forwarding node and the terminal, and compute a transmission parameter of the one downlink beam (or the one uplink beam) according to a transmission parameter of the one uplink beam (or the one downlink beam). However, the forwarding node may not have sufficient information to determine correspondence between uplink and downlink links, such that the forwarding node may be unable to compute the transmission parameter of the one downlink beam (or the one uplink beam) according to the transmission parameter of the one uplink beam (or the one downlink beam). That is, the forwarding node further needs to conduct beam training on the downlink beam and the uplink beam between the forwarding node and the terminal separately, such that the transmission parameters of the downlink channel and the uplink channel between the forwarding node and the terminal are determined. Thus, high resource and time consumption of the forwarding node is caused probably, and a decrease in resources for information transmission and an increase in a transmission delay can be achieved.

However, in the embodiment of the disclosure, the forwarding node may determine one uplink channel (or one downlink channel) associated with one downlink channel (or one uplink channel) between the forwarding node and the terminal according to auxiliary information transmitted by the access network device. In this way, the forwarding node may directly determine a transmission parameter of one downlink channel (or one uplink channel) according to a transmission parameter of the one uplink channel (or the one downlink channel), and beam training does not need to be conducted on the downlink beam and the uplink beam between the forwarding node and the terminal separately. Thus, resource and time consumption of the forwarding node can be reduced, and an increase in resources for information transmission and a decrease in a transmission delay can be achieved.

FIG. 5 shows a flow diagram of a method for determining a transmission parameter according to an embodiment of the disclosure. As shown in FIG. 5, the method for determining a transmission parameter according to the embodiment of the disclosure may include step 101 to step 104.

Step 101, a first network side device transmits auxiliary information to a forwarding node.

For example, in the embodiment of the disclosure, the first network side device may be any one of the following: an access network device and another forwarding node. In some embodiments, the access network device may be a base station. Another forwarding node may be an L1 forwarding node.

In a case that a network side device is another forwarding node, another forwarding node may first receive the auxiliary information from the access network device, and then transmit the auxiliary information to the forwarding node.

For example, in the embodiment of the disclosure, the forwarding node may be the L1 forwarding node.

In the embodiment of the disclosure, the auxiliary information is configured to indicate information related to a first transmission channel. The first transmission channel is: an uplink channel or a downlink channel whose radio signal is to be forwarded between the forwarding node and a terminal. The auxiliary information is configured to enable the forwarding node to determine a second transmission channel associated with the first transmission channel, such that a transmission parameter of the first transmission channel is determined according to a transmission parameter of the second transmission channel. A transmission direction of the second transmission channel is different from a transmission direction of the first transmission channel.

For example, in the embodiment of the disclosure, the auxiliary information may be configured to explicitly or implicitly indicate at least one of the following conditions:
reciprocity exists between the first transmission channel and the second transmission channel;
the first transmission channel and the second transmission channel correspond to a same access link; and
the first transmission channel and the second transmission channel correspond to a same terminal.

It should be noted that the sentence that “the first transmission channel and the second transmission channel correspond to a same access link” may be understood as follows: the first transmission channel and the second transmission channel belong to the same access link. The sentence that “the first transmission channel and the second transmission channel correspond to a same terminal” may be understood as follows: both the first transmission channel and the second transmission channel are transmission channels between the forwarding node and the same terminal.

For example, in the embodiment of the disclosure, the first transmission channel may be: a downlink channel for forwarding information to the terminal after the forwarding node receives the information of the first network side device; or an uplink channel for receiving information transmitted by the terminal to the first network side device from the terminal.

For example, in the embodiment of the disclosure, the second transmission channel may be: an uplink channel for receiving information transmitted by the terminal to the first network side device from the terminal; or a downlink channel for forwarding information to the terminal after the forwarding node receives the information of the first network side device. It may be understood that the second transmission channel is a reverse channel of the first transmission channel.

For example, in the embodiment of the disclosure, the second transmission channel and the first transmission channel are transmission channels in a same access link.

It may be understood that reciprocity exists between the second transmission channel and the first transmission channel. That is, the transmission parameter of the first transmission channel may be determined according to the transmission parameter of the second transmission channel.

For example, in the embodiment of the disclosure, the second transmission channel is configured to forward a radio signal between the forwarding node and the terminal for an ith time. The first transmission channel is configured to forward a radio signal between the forwarding node and the terminal for an (i+m)th time, where i and m denote positive integers.

For example, if the second transmission channel is the uplink channel and the first transmission channel is the downlink channel, the second transmission channel is configured to forward a radio signal between the forwarding node and the terminal for a first time, and the first transmission channel is configured to forward a radio signal between the forwarding node and the terminal for a second time. That is, a transmission parameter of next downlink forwarding may be determined according to a transmission parameter of previous uplink forwarding.

Further, for example, if the second transmission channel is the downlink channel and the first transmission channel is the uplink channel, the second transmission channel is configured to forward a radio signal between the forwarding node and the terminal for a second time, and the first transmission channel is configured to forward a radio signal between the forwarding node and the terminal for a third time. That is, a transmission parameter of next uplink forwarding may be determined according to a transmission parameter of previous downlink forwarding.

For example, in the embodiment of the disclosure, in a case that a target transmission channel is the uplink channel, a transmission parameter of the target transmission channel may include at least one of the following: an incoming wave direction, an incoming wave beam width, incoming wave strength information, and preferred reception weight matrix information. In a case that a target transmission channel is the downlink channel, a transmission parameter of the target transmission channel may include at least one of the following: transmission beam direction information, beam width information, beam gain information, and precoding matrix information.

The target transmission channel is either of the first transmission channel and the second transmission channel.

For example, in the embodiment of the disclosure, after the first network side device transmits, to the forwarding node, control information (for example, first control information in the following embodiments) configured to control information transmission on the first transmission channel, the first network side device may transmit the auxiliary information to the forwarding node. For example, the first network side device may transmit the auxiliary information to the forwarding node while transmitting the control information to the forwarding node.

Step 102, the forwarding node receives the auxiliary information from the first network side device.

In the embodiment of the disclosure, the auxiliary information is configured to indicate information related to the first transmission channel. The first transmission channel is: the uplink channel or the downlink channel whose radio signal is to be forwarded between the forwarding node and the terminal.

For example, in the embodiment of the disclosure, after the first network side device transmits, to the forwarding node, the control information (for example, the first control information in the following embodiments) configured to control information transmission on the first transmission channel, the forwarding node may receive the auxiliary information from the first network side device. For example, the forwarding node may receive the auxiliary information from the first network side device while receiving the control information from the first network side device.

Step 103, the forwarding node determines the second transmission channel associated with the first transmission channel according to the auxiliary information.

In the embodiment of the disclosure, the transmission direction of the second transmission channel is different from the transmission direction of the first transmission channel.

For example, in the embodiment of the disclosure, the forwarding node may directly determine the second transmission channel according to the auxiliary information. For example, the forwarding node may determine control information (for example, second control information in the following embodiments) corresponding to the auxiliary information according to the auxiliary information, and determine a transmission channel corresponding to the control information as the second transmission channel.

It should be noted that the “control information corresponding to the auxiliary information” may be understood as follows: information included in the control information is matched with (for example, is the same as) the auxiliary information. For example, information used when the first network side device transmits the control information is matched with (for example, is the same as) information used when the auxiliary information is transmitted. For example, the control information is indicated by the auxiliary information. The “transmission channel corresponding to the control information” may be understood as: a transmission channel in which the control information controls the forwarding node to conduct information transmission.

Step 104, the forwarding node determines the transmission parameter of the first transmission channel according to the transmission parameter of the second transmission channel.

For example, in the embodiment of the disclosure, the forwarding node may compute the transmission parameter of the first transmission channel according to the transmission parameter of the second transmission channel through a preset algorithm.

It should be noted that reference may be made to specific description in the related art for description of the preset algorithm, which is not repeated in the embodiment of the disclosure.

For example, in the embodiment of the disclosure, after the forwarding node determines the transmission parameter of the first transmission channel, the forwarding node may conduct information transmission with the terminal on the first transmission channel according to the transmission parameter of the first transmission channel.

In the method for determining a transmission parameter according to the embodiment of disclosure, the forwarding node may first receive the auxiliary information configured to indicate the information related to the first transmission channel from the first network side device. Then, the second transmission channel associated with the first transmission channel is determined according to the auxiliary information. Thus, the forwarding node may determine the transmission parameter of the first transmission channel according to the transmission parameter of the second transmission channel. The first transmission channel is: the uplink channel or the downlink channel whose radio signal is to be forwarded between the forwarding node and the terminal. The transmission direction of the second transmission channel is different from the transmission direction of the first transmission channel. The forwarding node may determine the second transmission channel associated with the first transmission channel according to the auxiliary information transmitted by the first network side device. In this way, the forwarding node may directly determine the transmission parameter of the first transmission channel according to the transmission parameter of the second transmission channel, and beam training does not need to be conducted on the downlink beam and the uplink beam between the forwarding node and the terminal separately, such that the transmission parameter of the first transmission channel can be determined. Thus, resource and time consumption of the forwarding node can be reduced, and an increase in resources for information transmission and a decrease in a transmission delay can be achieved. In this way, forwarding performance of the forwarding node can be improved.

Illustration will be provided below with a case that the first network side device transmits the auxiliary information to the forwarding node while transmitting the control information configured to control information transmission on the first transmission channel to the forwarding node as an example.

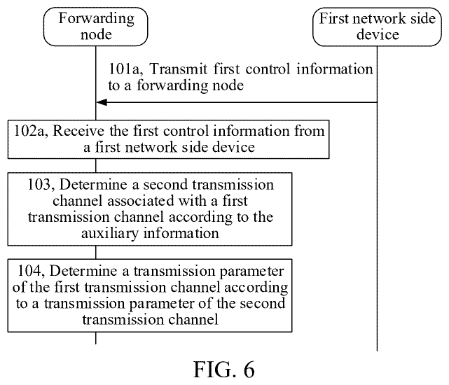

For example, in the embodiment of the disclosure, with reference to FIG. 5, as shown in FIG. 6, step 101 may be implemented through the following step 101a, and step 102 may be implemented through the following step 102a.

Step 101a, the first network side device transmits the first control information to the forwarding node.

In the embodiment of the disclosure, the first control information includes the auxiliary information.

For example, in the embodiment of the disclosure, the first control information may be: Side Control Information (SCI).

In the embodiment of the disclosure, the first control information is configured to control information transmission on the first transmission channel.

It may be understood that the first control information is configured to control the forwarding node to conduct uplink forwarding or downlink forwarding on the terminal.

Step 102a, the forwarding node receives the first control information from the first network side device.

In the embodiment of the disclosure, the first control information includes the auxiliary information.

In the embodiment of the disclosure, the first control information is configured to control information transmission on the first transmission channel.

A method for the forwarding node to determine the second transmission channel will be illustrated below with different examples.

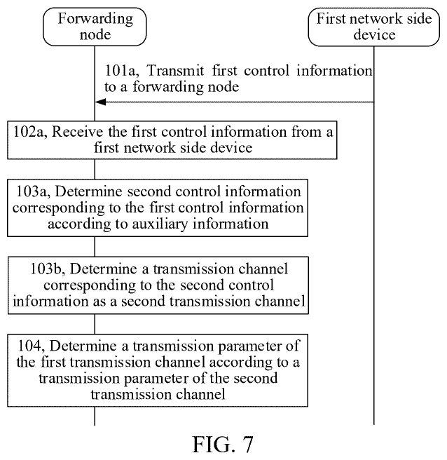

For example, in the embodiment of the disclosure, with reference to FIG. 6, as shown in FIG. 7, step 103 may be implemented through the following step 103a and step 103b.

Step 103a, the forwarding node determines the second control information corresponding to the first control information according to the auxiliary information.

In the embodiment of the disclosure, the second control information is configured to control information transmission on the second transmission channel.

For example, in the embodiment of the disclosure, the second control information may be side control information.

For example, in the embodiment of the disclosure, at least one piece of historical control information is stored in the forwarding node, and each piece of historical control information includes one piece of target information, such that the forwarding node may determine one piece of target information matched with (for example, the same as) the auxiliary information from at least one piece of target information, and historical control information corresponding to the one piece of target information is determined as the second control information.

For each of the at least one piece of historical control information, one piece of target information included in one piece of historical control information is configured to indicate information related to a transmission channel corresponding to the one piece of historical control information.

Illustration will be provided below with four different examples.

In an example, the auxiliary information includes a first device identifier of the terminal. A device identifier included in the second control information is matched with the first device identifier.

For example, the first device identifier may be: a User Equipment Identification (UE_ID).

The forwarding node may determine one device identifier the same as the first device identifier from at least one piece of target information (that is, at least one device identifier) included in the at least one piece of historical control information stored in the forwarding node according to the first device identifier, and determine one piece of historical control information corresponding to the one device identifier as the second control information.

In another example, the auxiliary information includes a first Radio Network Temporary Identity (RNTI). The first RNTI is an RNTI used when the first network side device transmits the first control information to the forwarding node. An RNTI used when the first network side device transmits the second control information to the forwarding node is matched with the first RNTI.

The forwarding node may determine one RNTI the same as the first RNTI from at least one piece of target information (that is, at least one RNTI) included in the at least one piece of historical control information stored in the forwarding node according to the first RNTI, and determine one piece of historical control information corresponding to the one RNTI as the second control information.

In yet another example, the auxiliary information includes a first link identifier. A link identifier included in the second control information is matched with the first link identifier.

For example, the first link identifier may be: a link ID.

The forwarding node may determine one link identifier the same as the first link identifier from at least one piece of target information (that is, at least one link identifier) included in the at least one piece of historical control information stored in the forwarding node according to the first link identifier, and determine one piece of historical control information corresponding to the one link identifier as the second control information.

In yet another example, the auxiliary information includes a first channel association indication. A value of a channel association indication included in the second control information is matched with a value of the first channel association indication.

The forwarding node may determine one channel association indication having a same value as the first channel association indication from at least one piece of target information (that is, at least one channel association indication) included in the at least one piece of historical control information stored in the forwarding node according to the value of the first channel association indication, and determine one piece of historical control information corresponding to the one channel association indication as the second control information.

For example, the first network side device may further indicate a determination method, used by the forwarding node, for corresponding control information according to the auxiliary information.

For example, in the embodiment of the disclosure, the first control information further includes first indication information. The first indication information is configured to indicate a determination method for determining the second control information. For example, step 103a may be implemented through the following step 103a1.

Step 103a1, the forwarding node determines the second control information corresponding to the first control information through the determination method according to the auxiliary information.

For example, the determination method, indicated by the first indication information, for determining the second control information may include any one of the following methods:
a determination method based on a device identifier;
a determination method based on an RNTI;
a determination method based on a link identifier; and
a determination method based on a channel association indication.

In a case that the determination method, indicated by the first indication information, for determining the second control information is the determination method based on a device identifier, the auxiliary information includes the first device identifier, and the at least one piece of historical control information includes at least one device identifier. Thus, the forwarding node may determine the second control information corresponding to the first control information according to the first device identifier.

In a case that the determination method, indicated by the first indication information, for determining the second control information is the determination method based on an RNTI, the auxiliary information includes the first RNTI, and the at least one piece of historical control information includes at least one RNTI. Thus, the forwarding node may determine the second control information corresponding to the first control information according to the first RNTI.

In a case that the determination method, indicated by the first indication information, for determining the second control information is the determination method based on a link identifier, the auxiliary information includes the first link identifier, and the at least one piece of historical control information includes at least one link identifier. Thus, the forwarding node may determine the second control information corresponding to the first control information according to the first link identifier.

In a case that the determination method, indicated by the first indication information, for determining the second control information is the determination method based on a channel association indication, the auxiliary information includes the first channel association indication, and the at least one piece of historical control information includes at least one channel association indication. Thus, the forwarding node may determine the second control information corresponding to the first control information according to the first channel association indication.

In this way, the forwarding node may determine the second control information corresponding to the first control information according to the auxiliary information through the determination method, indicated by the first network side device, for determining the second control information, and the forwarding node does not need to determine the determination method for determining the second control information by itself. Thus, accuracy of the second control information determined can be improved, such that accuracy of determining the transmission parameter of the first transmission channel can be improved.

Step 103b, the forwarding node determines a transmission channel corresponding to the second control information as the second transmission channel.

In the embodiment of the disclosure, the forwarding node may determine a transmission channel in which the second control information controls the forwarding node to conduct information transmission as the second transmission channel.

In this way, the forwarding node may accurately determine the second control information corresponding to the first control information according to the auxiliary information. Thus, accuracy of determining the second transmission channel can be improved, such that accuracy of determining the transmission parameter of the first transmission channel can be improved.

A signaling flow between the forwarding node and the first network side device of the embodiment of the disclosure will be illustrated below with specific examples.

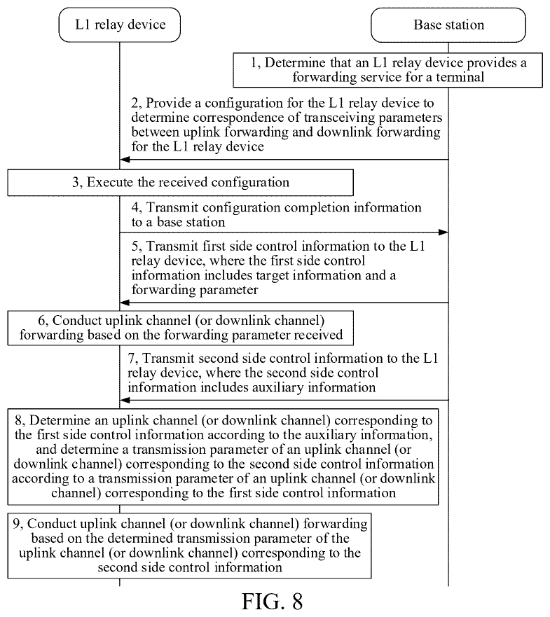

FIG. 8 shows a schematic diagram of a signaling flow between a forwarding node and a first network side device. As shown in FIG. 8, the forwarding node is an L1 relay device, and the first network side device is a base station (gNB). A signaling flow between an L1 forwarding node and the base station may include the following steps:
1, The base station determines that the L1 relay device provides a forwarding service for a terminal.
2, The base station provides a configuration (for example, first indication information in the embodiments) for the L1 relay device to determine correspondence of transceiving parameters between uplink forwarding and downlink forwarding for the L1 relay device.
3, The L1 relay device executes the received configuration.
4, The L1 relay device transmits configuration completion information to the base station.
5, The base station transmits first side control information (for example, second control information in the embodiments) to the L1 relay device. The first side control information includes target information and a forwarding parameter.
6, The L1 relay device may conduct uplink channel (or downlink channel) forwarding based on the forwarding parameter received.
7, The base station transmits second side control information to the L1 relay device. The second side control information includes auxiliary information.
8, The L1 relay device determines a corresponding uplink channel (or downlink channel), that is, an uplink channel (or downlink channel) corresponding to the first side control information according to the auxiliary information, and determines a transmission parameter of an uplink channel (or downlink channel) corresponding to the second side control information according to a transmission parameter of an uplink channel (or downlink channel) corresponding to the first side control information.
9, The L1 relay device conducts uplink channel (or downlink channel) forwarding based on the determined transmission parameter of the uplink channel (or downlink channel) corresponding to the second side control information.

An execution body of the method for determining a transmission parameter according to the embodiment of the disclosure may be an apparatus for determining a transmission parameter. In the embodiment of the disclosure, the apparatus for determining a transmission parameter according to the embodiment of the disclosure is illustrated by using the apparatus for determining a transmission parameter to execute the method for determining a transmission parameter as an example.

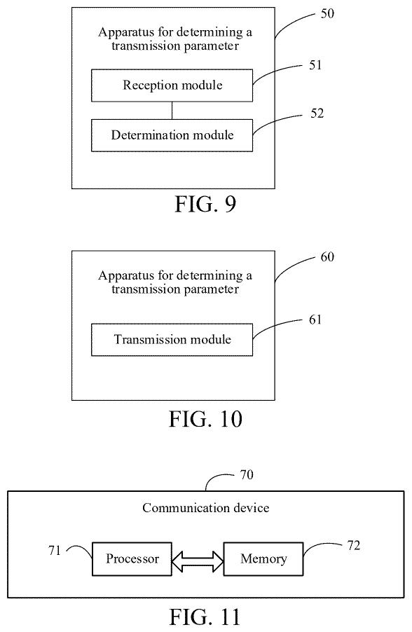

FIG. 9 shows a possible schematic structural diagram of an apparatus for determining a transmission parameter involved in an embodiment of the disclosure. As shown in FIG. 9, the apparatus 50 for determining a transmission parameter may include: a reception module 51 and a determination module 52.

The reception module 51 is configured to receive auxiliary information from a first network side device. The auxiliary information is configured to indicate information related to a first transmission channel. The first transmission channel is: an uplink channel or a downlink channel whose radio signal is to be forwarded between the apparatus 50 for determining a transmission parameter and a terminal. The determination module 52 is configured to determine a second transmission channel associated with the first transmission channel according to the auxiliary information received by the reception module 51; and determine a transmission parameter of the first transmission channel according to a transmission parameter of the second transmission channel. A transmission direction of the second transmission channel is different from a transmission direction of the first transmission channel.

In a possible implementation, the reception module 51 is configured to receive first control information from the first network side device. The first control information includes the auxiliary information. The first control information is configured to control information transmission on the first transmission channel.

In a possible implementation, the determination module 52 is configured to determine second control information corresponding to the first control information according to the auxiliary information; and determine a transmission channel corresponding to the second control information as the second transmission channel.

In a possible implementation, the auxiliary information includes a first device identifier of the terminal. A device identifier included in the second control information is matched with the first device identifier.

In a possible implementation, the auxiliary information includes a first RNTI. The first RNTI is an RNTI used when the first network side device transmits the first control information to the apparatus 50 for determining a transmission parameter. An RNTI used when the first network side device transmits the second control information to the apparatus 50 for determining a transmission parameter is matched with the first RNTI.

In a possible implementation, the auxiliary information includes a first link identifier. A link identifier included in the second control information is matched with the first link identifier.

In a possible implementation, the auxiliary information includes a first channel association indication. A value of a channel association indication included in the second control information is matched with a value of the first channel association indication.

In a possible implementation, the first control information further includes first indication information. The first indication information is configured to indicate a determination method for determining the second control information. For example, the determination module 52 is configured to determine the second control information corresponding to the first control information through the determination method according to the auxiliary information.

In a possible implementation, in a case that a target transmission channel is the uplink channel, a transmission reference of the target transmission channel includes at least one of the following: an incoming wave direction, an incoming wave beam width, incoming wave strength information, and preferred reception weight matrix information. In a case that a target transmission channel is the downlink channel, a transmission parameter of the target transmission channel includes at least one of the following: transmission beam direction information, beam width information, beam gain information, and precoding matrix information. The target transmission channel is either of the first transmission channel and the second transmission channel.

In the apparatus for determining a transmission parameter according to the embodiment of disclosure, the apparatus for determining a transmission parameter may determine the second transmission channel associated with the first transmission channel according to the auxiliary information transmitted by the first network side device. In this way, the apparatus for determining a transmission parameter may directly determine the transmission parameter of the first transmission channel according to the transmission parameter of the second transmission channel, and beam training does not need to be conducted on a downlink beam and an uplink beam between the apparatus for determining a transmission parameter and the terminal separately, such that the transmission parameter of the first transmission channel can be determined. Thus, resource and time consumption of the apparatus for determining a transmission parameter can be reduced, and an increase in resources for information transmission and a decrease in a transmission delay can be achieved. In this way, forwarding performance of the apparatus for determining a transmission parameter can be improved.

The apparatus for determining a transmission parameter in the embodiment of the disclosure may be an electronic device, and for example, an electronic device having an operating system, or may be a component in an electronic device, and for example, an integrated circuit or a chip. The electronic device may be a terminal, or may be another device other than a terminal. For example, the terminal may include, but is not limited to, types of the terminal 11 listed above. Another device may be a server, a Network Attached Storage (NAS), etc., and is not specifically limited by the embodiment of the disclosure.

The apparatus for determining a transmission parameter according to the embodiment of the disclosure can implement all processes implemented in the method embodiments of FIG. 5 to FIG. 7, and achieve same technical effects. To avoid repetition, details will not be repeated herein.

FIG. 10 shows a possible schematic structural diagram of an apparatus for determining a transmission parameter involved in an embodiment of the disclosure. As shown in FIG. 10, the apparatus 60 for determining a transmission parameter may include: a transmission module 61.

The transmission module 61 is configured to transmit auxiliary information to a forwarding node. The auxiliary information is configured to indicate information related to a first transmission channel. The first transmission channel is: an uplink channel or a downlink channel whose radio signal is to be forwarded between the forwarding node and a terminal. The auxiliary information is configured to enable the forwarding node to determine a second transmission channel associated with the first transmission channel, such that a transmission parameter of the first transmission channel is determined according to a transmission parameter of the second transmission channel. A transmission direction of the second transmission channel is different from a transmission direction of the first transmission channel.

In a possible implementation, the transmission module 61 is configured to transmit first control information to the forwarding node. The first control information includes the auxiliary information. The first control information is configured to control information transmission on the first transmission channel.

In a possible implementation, the first control information further includes first indication information. The first indication information is configured to indicate a determination method for determining the second control information by the forwarding node.

In the apparatus for determining a transmission parameter according to the embodiment of disclosure, the forwarding node may determine the second transmission channel associated with the first transmission channel according to the auxiliary information transmitted by the apparatus for determining a transmission parameter. In this way, the forwarding node may directly determine the transmission parameter of the first transmission channel according to the transmission parameter of the second transmission channel, and beam training does not need to be conducted between the forwarding node and the terminal, such that the transmission parameter of the first transmission channel can be determined. Thus, a delay of the forwarding node in forwarding information between the apparatus for determining a transmission parameter and the terminal can be reduced. In this way, forwarding performance of the forwarding node can be improved.

The apparatus for determining a transmission parameter in the embodiment of the disclosure may be an electronic device, and for example, an electronic device having an operating system, or may be a component in an electronic device, and for example, an integrated circuit or a chip. The electronic device may be a terminal, or may be another device other than a terminal. For example, the terminal may include, but is not limited to, types of the terminal 11 listed above. Another device may be a server, a NAS, etc., and is not specifically limited by the embodiment of the disclosure.

The apparatus for determining a transmission parameter according to the embodiment of the disclosure can implement all processes implemented in the method embodiments of FIG. 5 to FIG. 7, and achieve same technical effects. To avoid repetition, details will not be repeated herein.

For example, in the embodiment of the disclosure, as shown in FIG. 11, an embodiment of the disclosure further provides a communication device 70. The communication device includes a processor 71 and a memory 72. The memory 72 stores a program or an instruction runnable on the processor 71. For example, in a case that the communication device 70 is a network side device, when the program or the instruction is executed by the processor 71, all steps of the embodiment of the method for determining a transmission parameter are implemented, and same technical effects can be achieved. To avoid repetition, details will not be repeated herein.

An embodiment of the disclosure further provides a network side device. The network side device includes a processor and a communication interface. The communication interface is configured to receive auxiliary information from a first network side device. The auxiliary information is configured to indicate information related to a first transmission channel. The first transmission channel is: an uplink channel or a downlink channel whose radio signal is to be forwarded between a forwarding node and a terminal. The processor is configured to determine a second transmission channel associated with the first transmission channel according to the auxiliary information; and determine a transmission parameter of the first transmission channel according to a transmission parameter of the second transmission channel. A transmission direction of the second transmission channel is different from a transmission direction of the first transmission channel. For example, the communication interface is configured to transmit the auxiliary information to the forwarding node. The auxiliary information is configured to indicate the information related to the first transmission channel. The first transmission channel is: the uplink channel or the downlink channel whose radio signal is to be forwarded between the forwarding node and the terminal. The auxiliary information is configured to enable the forwarding node to determine the second transmission channel associated with the first transmission channel, such that the transmission parameter of the first transmission channel is determined according to the transmission parameter of the second transmission channel. The transmission direction of the second transmission channel is different from the transmission direction of the first transmission channel. The embodiment of the network side device corresponds to the method embodiment of the forwarding node, or corresponds to the method embodiment of the network side device. Various implementation processes and implementations of the method embodiment may be all applied to the embodiment of the network side device and can achieve same technical effects.

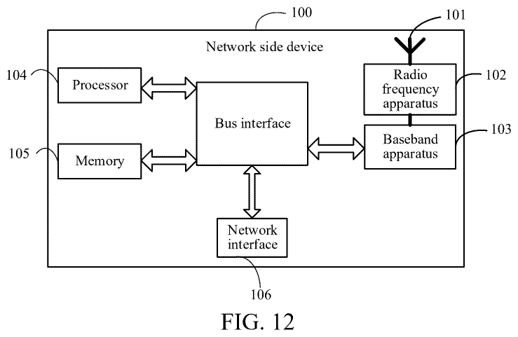

For example, an embodiment of the disclosure further provides a network side device. As shown in FIG. 12, the network side device 100 includes: an antenna 101, a radio frequency apparatus 102, a baseband apparatus 103, a processor 104, and a memory 105. The antenna 101 is connected to the radio frequency apparatus 102. In an uplink direction, the radio frequency apparatus 102 receives information through the antenna 101, and transmits the received information to the baseband apparatus 103 for processing. In a downlink direction, the baseband apparatus 103 processes to-be-transmitted information, and transmits the information to the radio frequency apparatus 102. The radio frequency apparatus 102 processes the received information and then transmits the information through the antenna 101.

In the embodiment, the method executed by the forwarding node or the network side device may be implemented in the baseband apparatus 103. The baseband apparatus 103 includes a baseband processor.

The baseband apparatus 103 may include, for example, at least one baseband board. The baseband board is provided with a plurality of chips. As shown in FIG. 12, one of the chips is a baseband processor for example, and is connected to the memory 105 through a bus interface, such that a program in the memory 105 is invoked to execute operations of a network device shown in the method embodiment.

The network side device may further include a network interface 106. The interface is, for example, a common public radio interface (CPRI).

For example, the network side device 100 of the embodiment of the disclosure further includes: an instruction or a program stored in the memory 105 and runnable on the processor 104. The processor 104 invokes the instruction or the program in the memory 105 to execute the method executed by each module shown in FIG. 12, and achieves a same technical effect. To avoid repetition, details will not be repeated herein.

An embodiment of the disclosure further provides a readable storage medium. The readable storage medium stores a program or an instruction. When the program or the instruction is executed by a processor, all processes of the embodiment of the method for determining a transmission parameter are implemented, and same technical effects can be achieved. To avoid repetition, details will not be repeated herein.

The processor is a processor of the terminal of the embodiment. The readable storage medium includes a computer-readable storage medium, such as a computer read-only memory (ROM), a random access memory (RAM), a magnetic disk, or an optical disk.

An embodiment of the disclosure further provides a chip. The chip includes a processor and a communication interface. The communication interface is coupled to the processor. The processor is configured to run a program or an instruction, such that all processes of the embodiment of the method for determining a transmission parameter are implemented, and same technical effects can be achieved. To avoid repetition, details will not be repeated herein.

It should be understood that the chip mentioned in the embodiment of the disclosure may be referred to as a system on a chip, a system chip, a chip system, a system-on-chip, etc.

An embodiment of the disclosure further provides a computer program/program product. The computer program/program product is stored in a storage medium. The computer program/program product is executed by at least one processor, such that all processes of the embodiment of the method for determining a transmission parameter are implemented, and same technical effects can be achieved. To avoid repetition, details will not be repeated herein.

An embodiment of the disclosure further provides a system for determining a transmission parameter. The system includes: a forwarding node and a first network side device. The forwarding node is configured to execute steps of the method corresponding to the forwarding node. The first network side device is configured to execute steps of the method corresponding to the first network side device.

It should be noted that terms “include”, “comprise”, “involve”, or their any other variations herein are intended to cover non-exclusive inclusions, such that a process, a method, an article, or an apparatus including a series of elements not only includes those elements, but also includes other elements that are not explicitly listed, or also includes inherent elements of the process, the method, the article, or the apparatus. Without more restrictions, the elements defined by the sentence “including a . . . ” or “comprising a . . . ” do not exclude existence of other identical elements in the process, the method, the article, or the apparatus including the elements. In addition, it should be noted that a scope of the method and the apparatus in an implementation of the disclosure is not limited to execution of functions in order shown or discussed, and may further include execution of functions involved in a substantially simultaneous manner or in reverse order. For example, the method described may be executed in order different from that described, and various steps may be added, omitted, or combined. Moreover, features described with reference to some examples may be combined in other examples.

From description of the implementation, those skilled in the art may clearly understand that the methods of the embodiments may be implemented by means of software plus a necessary general-purpose hardware platform, or by means of hardware. In many cases, the former is a better implementation. With such understanding, the technical solution of the disclosure, in essence or from the view of part contributing to the prior art, may be embodied in a form of a computer software product. The computer software product is stored in a storage medium (such as an ROM/RAM, a magnetic disk, and an optical disk) and includes several instructions configured to enable a terminal (which may be a mobile phone, a computer, a server, an air conditioner, a network device, etc.) to execute the method according to each embodiment of the disclosure.

The embodiments of the disclosure are described above with reference to the accompanying drawings, but the disclosure is not limited to the above specific implementations. The specific implementations are merely illustrative rather than restrictive. Inspired by the disclosure, those of ordinary skill in the art may still make many forms without departing from the essence of the disclosure and the protection scope of the claims, which all fall within protection of the disclosure.

What is claimed is:

1. A method for determining a transmission parameter, comprising:
receiving, by a forwarding node, auxiliary information from a first network side device, wherein the auxiliary information is configured to indicate information related to a first transmission channel, and the first transmission channel is an uplink channel or a downlink channel whose radio signal is to be forwarded between the forwarding node and a terminal;
determining, by the forwarding node, a second transmission channel associated with the first transmission channel according to the auxiliary information; and
determining, by the forwarding node, a transmission parameter of the first transmission channel according to a transmission parameter of the second transmission channel, wherein
a transmission direction of the second transmission channel is different from a transmission direction of the first transmission channel.

2. The method according to claim 1, wherein the receiving, by the forwarding node, the auxiliary information from the first network side device comprises:
receiving, by the forwarding node, first control information from the first network side device, wherein the first control information comprises the auxiliary information, and the first control information is configured to control information transmission on the first transmission channel.

3. The method according to claim 2, wherein the determining, by the forwarding node, the second transmission channel associated with the first transmission channel according to the auxiliary information comprises:
determining, by the forwarding node, second control information corresponding to the first control information according to the auxiliary information; and
determining, by the forwarding node, a transmission channel corresponding to the second control information as the second transmission channel.

4. The method according to claim 3, wherein the auxiliary information comprises a first device identifier of the terminal; and
a device identifier comprised in the second control information is matched with the first device identifier.

5. The method according to claim 3, wherein the auxiliary information comprises a first radio network temporary identifier (RNTI), and the first RNTI is an RNTI used when the first network side device transmits the first control information to the forwarding node; and
an RNTI used when the first network side device transmits the second control information to the forwarding node is matched with the first RNTI.

6. The method according to claim 3, wherein the auxiliary information comprises a first link identifier; and
a link identifier comprised in the second control information is matched with the first link identifier.

7. The method according to claim 3, wherein the auxiliary information comprises a first channel association indication; and
a value of a channel association indication comprised in the second control information is matched with a value of the first channel association indication.

8. The method according to claim 3, wherein the first control information further comprises first indication information, and the first indication information is configured to indicate a determination method for determining the second control information,
wherein the determining, by the forwarding node, second control information corresponding to the first control information according to the auxiliary information comprises:
determining, by the forwarding node, the second control information corresponding to the first control information through the determination method according to the auxiliary information.

9. The method according to claim 1, wherein when a target transmission channel is the uplink channel, a transmission reference of the target transmission channel comprises at least one of the following: an incoming wave direction, an incoming wave beam width, incoming wave strength information, or preferred reception weight matrix information,
when a target transmission channel is the downlink channel, a transmission parameter of the target transmission channel comprises at least one of the following: transmission beam direction information, beam width information, beam gain information, or precoding matrix information, wherein
the target transmission channel is either of the first transmission channel or the second transmission channel.

10. A method for determining a transmission parameter, comprising:
transmitting, by a first network side device, auxiliary information to a forwarding node, wherein the auxiliary information is configured to indicate information related to a first transmission channel, and the first transmission channel is an uplink channel or a downlink channel whose radio signal is to be forwarded between the forwarding node and a terminal, wherein
the auxiliary information is configured to enable the forwarding node to determine a second transmission channel associated with the first transmission channel, such that a transmission parameter of the first transmission channel is determined according to a transmission parameter of the second transmission channel; and a transmission direction of the second transmission channel is different from a transmission direction of the first transmission channel.

11. The method according to claim 10, wherein the transmitting, by the first network side device, the auxiliary information to a forwarding node comprises:
transmitting, by the first network side device, first control information to the forwarding node, wherein the first control information comprises the auxiliary information, and the first control information is configured to control information transmission on the first transmission channel.

12. The method according to claim 11, wherein the first control information further comprises first indication information, and the first indication information is configured to indicate a determination method for determining second control information by the forwarding node.

13. A network side device, comprising a processor and a memory storing instructions, wherein the instructions, when executed by the processor, cause the processor to perform operations comprising:
receiving auxiliary information from a first network side device, wherein the auxiliary information is configured to indicate information related to a first transmission channel, and the first transmission channel is an uplink channel or a downlink channel whose radio signal is to be forwarded between the network side device and a terminal;
determining a second transmission channel associated with the first transmission channel according to the auxiliary information; and
determining a transmission parameter of the first transmission channel according to a transmission parameter of the second transmission channel, wherein
a transmission direction of the second transmission channel is different from a transmission direction of the first transmission channel.

14. The network side device according to claim 13, wherein the receiving the auxiliary information from the first network side device comprises:
receiving first control information from the first network side device, wherein the first control information comprises the auxiliary information, and the first control information is configured to control information transmission on the first transmission channel.

15. The network side device according to claim 14, wherein the determining the second transmission channel associated with the first transmission channel according to the auxiliary information comprises:
determining second control information corresponding to the first control information according to the auxiliary information; and
determining a transmission channel corresponding to the second control information as the second transmission channel.

16. The network side device according to claim 15, wherein the auxiliary information comprises a first device identifier of the terminal; and
a device identifier comprised in the second control information is matched with the first device identifier.

17. The network side device according to claim 15, wherein the auxiliary information comprises a first radio network temporary identifier (RNTI), and the first RNTI is an RNTI used when the first network side device transmits the first control information to the network side device; and
an RNTI used when the first network side device transmits the second control information to the network side device is matched with the first RNTI.

18. The network side device according to claim 15, wherein the auxiliary information comprises a first link identifier; and
a link identifier comprised in the second control information is matched with the first link identifier.

19. The network side device according to claim 15, wherein the auxiliary information comprises a first channel association indication; and
a value of a channel association indication comprised in the second control information is matched with a value of the first channel association indication.

20. The network side device according to claim 15, wherein the first control information further comprises first indication information, and the first indication information is configured to indicate a determination method for determining the second control information,
wherein the determining second control information corresponding to the first control information according to the auxiliary information comprises:
determining the second control information corresponding to the first control information through the determination method according to the auxiliary information.
